(19) United States
(12) Patent Application Publication
(10) Pub. No.: US 2019/0205360 A1
(43) Pub. Date: Jul. 4, 2019

(54) METHOD FOR PRIORITIZING CANDIDATE OBJECTS

(71) Applicants: University of Southern California, Los Angeles, CA (US); Chevron U.S.A. Inc., San Ramon, CA (US)

(72) Inventors: CHUNGMING CHEUNG, Los Angeles, CA (US); PALASH GOYAL, Los Angeles, CA (US); ARASH SABER TEHRANI, Los Angeles, CA (US); VIKTOR K. PRASANNA, Pacific Palisades, CA (US); LISA ANN BRENSKELLE, Houston, TX (US)

(73) Assignees: University of Southern California, Los Angeles, CA (US); Chevron U.S.A. Inc., San Ramon, CA (US)

(21) Appl. No.: 16/235,387

(22) Filed: Dec. 28, 2018

Related U.S. Application Data
(60) Provisional application No. 62/612,222, filed on Dec. 29, 2017.

(51) Int. Cl. G06F 17/18; G06N 20/10; G06N 3/08; E21B 47/00

(52) U.S. Cl. CPC G06F 17/18; G06N 20/10; E21B 2041/0028; E21B 47/00; G06N 3/084

(57) ABSTRACT

A computer-implemented method for prioritizing candidate objects on which to perform a physical process includes receiving a time series history of measurements from each of a plurality of candidate objects at a data processing framework. The method further includes reducing dimensionality of the time series history of measurements with a convolutional autoencoder to obtain latent features for each of the plurality of candidate objects. The method also includes applying a kernel regression model to the latent features to generate a predicted value of physical output for performing the physical process on each of the plurality of candidate objects. The method additionally includes generating a prioritization of the candidate objects based on the values of physical output. The method involves selecting fewer than all of the plurality of candidate objects on which to perform the physical process. The selected candidate objects are based on the prioritization.

### CROSS-REFERENCE TO RELATED APPLICATIONS

This application claims priority to U.S. provisional application No. 62/612,222 filed Dec. 29, 2017, which is incorporated by reference in its entirety herein.

### TECHNICAL FIELD

The present disclosure relates generally to prioritizing candidate objects for a physical process based on a time series history of measurements. In particular, the present disclosure relates to prioritizing candidate oil wells for a steam job, or candidate pumps for slippage testing.

### BACKGROUND

In general, candidate objects can each be associated with a large number of measurements over time (e.g., hundreds or thousands). It is difficult to deduce patterns of change in the measurements over time in order to select a set of candidate objects on which to perform a physical process to achieve the greatest benefit (e.g., physical output). This is especially true when the patterns of change are non-linear. There is a need for a method for processing large amounts of data over time associated with each candidate object in order to select the most promising candidate objects to which to apply a physical process.

A specific example of a candidate object and physical process applied to that candidate object are a candidate oil well and a steam job, respectively. Cyclic steam jobs maintain oil well productivity. They raise the temperature thereby lowering oil viscosity and increasing oil production. However, cyclic steam jobs are expensive, so it is not cost-effective to carry out steam injection on every well in the oil field. Given a limited budget, it is necessary to choose a limited number of wells for steam jobs. Hence, selecting a subset of wells for a steam job such that production is maximized with a minimal amount of resources is highly valuable.

It is difficult to select oil wells for a steam job from a group of oil wells to obtain the greatest benefit (e.g., oil production gain). Production increase depends on many features such as pump efficiency, temperature, and location. Dependency of oil production on these features is highly non-linear.

Still further, extraction of oil from wells is done using a pump, which brings oil to the ground surface. As a pump deteriorates over time, its efficiency (e.g., as measured by a ratio of amount of oil extracted to the amount of oil pulled) decreases. Slippage generally refers to oil traveling through the valve in the pump that is intended to keep oil from flowing back into the well when oil is pumped out. This slippage effect is one way a pump may lose efficiency. Slippage detection is important, because low production may be either due to such pump slippage, or may be due to well deterioration or clogging. However, only a limited number of slippage tests can be performed in a given time due to resource limitations, and therefore constant slippage testing of all pumps is not feasible.

Neural networks are capable of learning highly non-linear functions and patterns. They are widely used in the oil industry and specifically for understanding and analyzing steam jobs, and in some instances slippage detection. However, improvements are needed.

### SUMMARY

In accordance with the present disclosure, the above and other issues are addressed by the following:

In a first aspect, a computer-implemented method for prioritizing candidate objects on which to perform a physical process is disclosed. The method includes receiving a time series history of measurements from each of a plurality of candidate objects at a data processing framework. The method further includes reducing dimensionality of the time series history of measurements with a convolutional autoencoder to obtain latent features for each of the plurality of candidate objects. The method also includes applying a kernel regression model to the latent features to generate a predicted value of physical output for performing the physical process on each of the plurality of candidate objects. The method includes generating a prioritization of the candidate objects based on the values of physical output. Additionally, the method includes selecting fewer than all of the plurality of candidate objects on which to perform the physical process. The selected candidate objects are based on the prioritization.

In a second aspect, a system comprises a processor and a memory operatively connected to the processor. The memory stores instructions that, when executed by the processor, cause the system to perform a method for prioritizing candidate objects on which to perform a physical process. The method includes reducing dimensionality of a time series history of measurements from each of a plurality of candidate objects with a convolutional autoencoder to obtain latent features for each of the plurality of candidate objects. The method further includes applying a kernel regression model to the latent features to generate a predicted value of physical output for performing a physical process on each of the plurality of candidate objects. The method also includes generating a prioritization of the candidate objects based on the values of physical output. Additionally, the method includes selecting fewer than all of the plurality of candidate objects on which to perform the physical process. The selected candidate objects are based on the prioritization.

In a third aspect, a computer-implemented method for selecting candidate oil wells at which to perform a steam job to enhance oil production gain from among a plurality of oil wells is disclosed. The method includes receiving a time series history of measurements for each of a plurality of oil wells at a data processing framework. The method further includes reducing dimensionality of the time series history of measurements with a convolutional autoencoder to obtain latent features for each of the plurality of oil wells. The method also includes applying a kernel regression model to the latent features to generate a predicted oil production gain for a steam job at each of the plurality of oil wells. The method includes generating a prioritization of the plurality of oil wells based on the predicted oil production gains. Additionally, the method includes selecting fewer than all of the plurality of oil wells on which to perform a steam job. The selected oil wells are based on the prioritization.

In a fourth aspect, a computer-implemented method for identifying mis-operation of equipment is disclosed. The method includes receiving a time series history of measurements from a piece of equipment at a data processing framework. The method further includes reducing dimensionality of the time series history of measurements with a convolutional autoencoder to obtain latent features for the piece of equipment. The method includes applying a kernel regression model to the latent features to generate a predicted value of physical output for performing a physical process on the piece of equipment. The method also includes determining whether the piece of equipment is mis-operating based on the value of physical output.

In a fifth aspect, a computer-implemented method for identifying mis-operation of equipment is disclosed. The method includes receiving a time series history of measurements from a piece of equipment at a data processing framework. The method further includes utilizing a convolutional autoencoder to determine a pattern in the time series history of measurements. The method also includes determining whether the pattern is anomalous.

### BRIEF DESCRIPTION OF THE DRAWINGS

FIG. 1 illustrates an exemplary environment used to implement methods and systems for prioritizing candidate objects on which to perform a physical process.

FIG. 2 illustrates a sequence of layers in a convolutional autoencoder, according to an example embodiment.

FIG. 3 illustrates a system for selecting candidate oil wells at which to perform a steam job to enhance oil production gain from among a plurality of oil wells, according to an example embodiment.

FIG. 4 illustrates a method for sorting and identifying candidate objects on which to perform a physical process, such as selecting candidate oil wells at which to perform a steam job to enhance oil production gain from among a plurality of oil wells, according to an example embodiment.

FIG. 5 illustrates a chart of mean square error based on feature map size in different layers of a neural network, in an example implementation.

FIG. 6 illustrates a chart of mean square error based on encode size, in an example implementation.

FIG. 7 illustrates a chart of mean square error based on filter size and various encode sizes, in an example implementation.

### DETAILED DESCRIPTION

As briefly described above, embodiments of the present disclosure are directed to methods and systems for prioritizing candidate objects on which to perform a physical process. These methods and systems can be used in various contexts and applications. For example, embodiments of the present disclosure are directed to methods and systems for selecting candidate oil wells at which to perform a steam job to enhance oil production gain from among a plurality of oil wells. Still further embodiments of the present disclosure are directed to methods and systems for detecting slippage in oil pumps, with an action being taken corresponding to repair of the oil pump. The present disclosure can also be implemented in circumstances in which prioritization of specific candidate objects is desired, in particular where prioritization can be based on historical operational data having high complexity.

The methods and systems of the present disclosure provide for data analysis that has improved accuracy in selecting candidate objects on which to perform a physical process to achieve the greatest benefit (i.e., physical output). For example, the methods and systems of the present disclosure provide for data analysis that has improved accuracy in selecting candidate oil wells at which to perform a steam job, or in identifying a pump experiencing slippage so the pump can be repaired to achieve the most oil production gain.

The methods and systems of the present disclosure also have improved computational efficiency as compared to the existing state of the art, which relies on hand crafting features in order to train a neural network. This is a time-consuming task.

As used herein, the following terms have the following meanings. The term “inferred production” refers to an estimate of the oil production amount of a well based upon a set of parameters, as opposed to measuring oil production of the well on a daily basis, which is expensive and impractical. The term “number of cycles” refers to the number of times the oil well is shut off per day due to low production. The term “runtime” refers to the total amount of time that the oil well is operational per day. The term “oil” is used for simplicity herein, but may refer to or include other hydrocarbons (e.g., natural gas, a combination of oil and some other hydrocarbon, etc.) in some embodiments.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

Concepts of the present disclosure are further described in “Deep Learning for Steam Job Candidate Selection” by Chung Ming Cheung, Palash Goyal, Arash Saber Tehrani, and Viktor K. Prasanna, Society of Petroleum Engineers, SPE Annual Technical Conference and Exhibition, 9-11 Oct. 2017, San Antonio, Tex., USA, the contents of which are incorporated by reference herein in their entirety. Further discussion of such concepts are discussed in “OReONet: Deep Convolutional Network for Oil Reservoir Optimization”, by Palash Goyal, Chung Ming Cheung, Viktor K. Prasanna, and Arash Saber Tehrani, 2017 IEEE International Conference on Big Data, 11-14 Dec. 2017, Boston, Mass., USA, the contents of which are also incorporated by reference herein in their entirety. Additional references cited or discussed herein are also each incorporated by reference herein in their entireties.

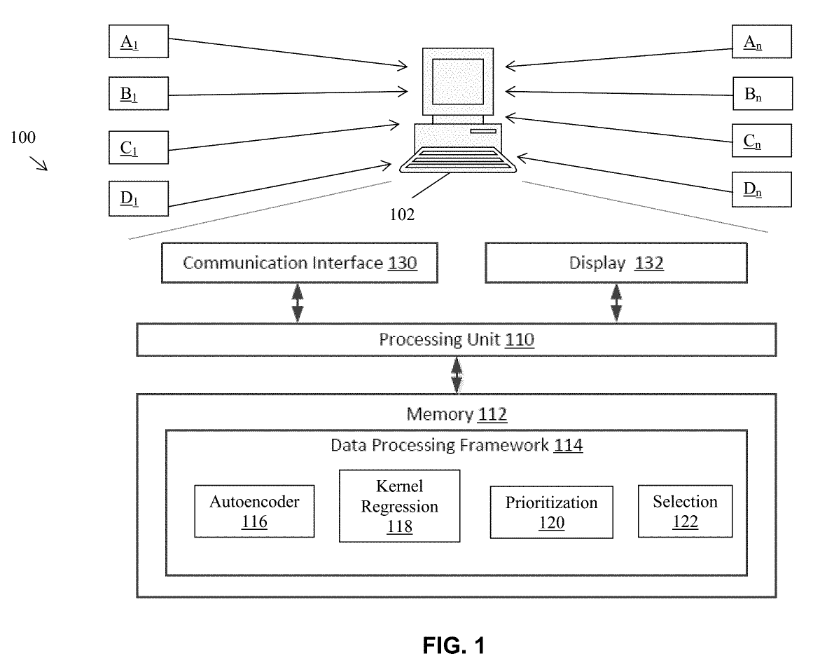

FIG. 1 shows an example system 100 used to implement the method for prioritizing candidate objects on which to perform a physical process. The example system 100 integrates a plurality of measurements over time from a plurality of candidate objects. As illustrated in the embodiment shown, a computing system 102 receives multiple time series of measurements A, B, C, and D from multiple candidate objects 1 through n (where n is an integer greater than 1). Time series of measurements A from candidate object 1 is labeled A₁, time series of measurements B from candidate object 1 is labeled B₁, time series of measurements C from candidate object 1 is labeled C₁, and time series of measurements D from candidate object 1 is labeled D₁. Similarly, time series of measurements A from candidate object n is labeled Aₙ, time series of measurements B from candidate object n is labeled Bₙ, time series of measurements C from candidate object n is labeled Cₙ, and time series of measurements D from candidate object n is labeled Dₙ.

In the embodiment shown, the computing system 102 includes a processor 110 and a memory 112. The processor 110 can be any of a variety of types of programmable circuits capable of executing computer-readable instructions to perform various tasks, such as mathematical and communication tasks.

The memory 112 can include any of a variety of memory devices, such as using various types of computer-readable or computer storage media. A computer storage medium or computer-readable medium may be any medium that can contain or store the program for use by or in connection with the instruction execution system, apparatus, or device. In example embodiments, the computer storage medium is embodied as a computer storage device, such as a memory or mass storage device. In particular embodiments, the computer-readable media and computer storage media of the present disclosure comprise at least some tangible devices, and in specific embodiments such computer-readable media and computer storage media include exclusively non-transitory media.

In the embodiment shown, the memory stores a data processing framework 114. The data processing framework 114 performs analysis of data, such as A₁ through Aₙ, B₁ through Bₙ, C₁ through Cₙ, and D₁ through Dₙ.

In the embodiment shown, the data processing framework 114 includes an autoencoder component 116, a kernel regression component 118, a prioritization component 120, and a selection component 122. In the example embodiment shown, the autoencoder component 116 receives time series of measurements A₁ through Aₙ, B₁ through Bₙ, C₁ through Cₙ, and D₁ through Dₙ and reduces dimensionality of the time series history of measurements using local correlation of neighboring values. The autoencoder component 116 takes the input as a matrix and finds a lower dimension representation of the high dimensional input. Assuming an input x, the autoencoder is configured to generate \tilde{x} as a representation of x in a smallest layer, assuming \hat{x} as the output.

In example embodiments, the autoencoder component 116 includes a loss function as well, defined as an error between input and output. The loss function can be defined by a mean squared error. By minimizing the error function, the network learns a representation of the input with values in the smallest layer, and then reproduces that input from those values. Because of local correlation of time series data, convolution layers are used, and feature maps are derived by convoluting a kernel K over the input matrix x. Each kernel creates a feature map, and multiple kernels are used per layer to create feature maps that are used as input for the next layer. Details of such an arrangement are provided below.

The convolutional autoencoder 116 identifies a certain kind of pattern or feature in the original matrix. In example embodiments, the autoencoder component 116 comprises a neural network and makes use of a layer called the convolutional layer. Accordingly, in such embodiments, the autoencoder component 116 is a convolutional autoencoder. The autoencoder component 116 may have one or more convolutional layers. The use of one or more convolutional layers allows discovery of high-level patterns in the time series history of measurements. The autoencoder component 116 provides latent features for each of the candidate objects 1 through n.

More specifically, in the embodiment shown, the autoencoder component 116 produces a lower dimensional representation of the original data and maps the original data to its latent variables. See D. Borsboom, G. J. Mellenbergh, and J. van Heerden, The theoretical status of latent variables, Psychological review, 110(2): 203-219, 2003, which is incorporated by reference in its entirety herein. Autoencoders are neural networks trained to produce encodings of inputs by attempting to reproduce the input from an intermediate layer with significantly less dimensions than the original data. Convolutional autoencoders make use of convolution layers, which is a kind of layer that exploit the local correlation of neighboring values to greatly reduce the number of parameters in the network. See A. Krizhevsky, I. Sutskever, and G. E. Hinton, ImageNet classification with deep convolutional neural networks. Advances in neural information processing systems, pages 1097-1105, 2012, which is incorporated by reference in its entirety herein; J. Masci, U. Meier, D. Ciresan, and J. Schmidhuber, Stacked convolutional auto-encoders for hierarchical feature extraction, International Conference on Artificial Neural Networks, pages 52-59. Springer, 2011, which is incorporated by reference in its entirety herein. The convolutional autoencoder can perform dimensionality reduction on the time series data before it is used as features for a kernel regression model. Thus, the convolutional autoencoder reduces dimensionality.

Dimensionality reduction is achieved by constructing a network by stacking neural layers with decreasing size, then increasing the sizes to reproduce an output of the same size as the input. The layer with the smallest size is the desired representation of the input.

x is the input, \hat{x} is the output, and \tilde{x} as the representation of x in the smallest layer. Essentially, the network before this layer can be seen as an encoder function ƒₑ(x, θₑ) that produces \tilde{x}, and a decoder function ƒ_{d}(\tilde{x}, θ_{d}) that produces \hat{x}, where θ_{d} and θₑ are parameters of the network.

The loss function of the autoencoder is defined as the error between the input and the output. One example of such error is mean squared error which is used in the model. By minimizing the error function, the network is forced to learn a representation of the input with values in the smallest layer, then reproduce the input from those values.

Such a network requires optimizing a huge number of parameters. In order to make it computationally plausible, and to exploit the local correlation of the time series data, convolution layers (see A. Krizhevsky, I. Sutskever, and G. E. Hinton. ImageNet classification with deep convolutional neural networks. Advances in neural information processing systems, pages 1097-1105, 2012, which is incorporated by reference in its entirety herein) are used in the architecture. In such layers, feature maps are derived by convoluting a kernel K over the input matrix x. Each kernel creates one feature map, and usually multiple kernels are used per layer to create multiple feature maps which are used as the input for the next layer.

Following one or several convolution layers is a max pooling layer, which downsamples the outputs of the layers. This helps reduce the size of the intermediate outputs and also helps promote invariance to translation in the representation. The max pooling layer downsamples the intermediate output by taking the maximum value for each rectangular neighborhood of a particular size.

In the example embodiment shown, the kernel regression component 118 applies a kernel regression model to the latent features. The kernel regression component 118 predicts a value of physical output for performing the physical process on each candidate object 1 through n.

A linear regression model is trained over the set Dₜᵣₐᵢₙ=<(x₁, y₁), . . . (x_{N}, y_{N})>where xᵢ∈ [symbol] ^{d} and yᵢ∈ [symbol] (d is the number of features). The assumed model is ƒ: x→y, with ƒ(x)=w₀+Σ_{d}w_{d}x^{d}=w₀+w^{T}x. The weights w are learned by minimizing the prediction error which is given as RSS(w)=Σₙ[yₙ−ƒ(xₙ)]²=Σₙ[yₙ−(w₀+Σ_{d}w_{d}xₙ^{d})]². The optimization is done using gradient descent algorithm where the gradient of the cost function is:

$$\frac{\partial }{\partial {w}_{d}} RSS ( w ) = - {\sum }_{n} 2 {x}_{n}^{d} [ {y}_{n} - ( {w}_{0} + {\sum }_{d} {w}_{d} {x}_{n}^{d} ) ]$$

The computation of gradient takes 0(nd) time and can be sped up by using mini-batch gradient descent instead of batch gradient descent. Assuming the number of mini-batches are b, the complexity for gradient calculation becomes

$$O ( \frac{nd}{b} ) .$$

A kernel regression model is based on linear regression but applies a kernel method to linear regression. Linear regression is discussed in Seber, George A., and Alan J. Lee. Linear regression analysis. Vol. 936. John Wiley & Sons, 2012, which is incorporated by reference in its entirety herein. The basic idea is to assign weights to each feature of a data set and make a prediction as a linear sum of weighted features. The prediction is compared against the ground truth and the weights are chosen such that the prediction is as close to the ground truth as possible.

To test the learned model, it can be evaluated on a held-out test set Dₜₑₛₜ. Computation of RSS(w*) is then possible on Dₜₑₛₜ where w* are the weights learnt from Dₜᵣₐᵢₙ. The test set is kept separate to quantify the generalization achieved by the model. Ideally, w* is learned which minimizes the test error. This can be achieved by dividing the training data into train and validation sets and choosing hyperparameters which minimize the error on validation set.

However, linear regression assumes a linear model. This is very restrictive and covers a small range of functions. To overcome this, kernel method (see Hofmann, Thomas; Schölkopf, Bernhard; Smola, Alexander J. (2008). “Kernel Methods in Machine Learning”, The Annals of Statistics, Vol. 36, No. 3, 1171-1220, which is incorporated by reference in its entirety herein) can be used. It is the technique of applying a non-linear transformation on the input and assigning weights to the transformed dimensions. The difficulty then is to find an appropriate transformation function for the input. Kernel method tackles this by not explicitly modeling the transformation function. Instead, it models the distance between points in the new space. The function, which models the distance between two points, is called the kernel function.

A kernel regression model is trained over the set Dₜᵣₐᵢₙ=<(x⁽¹⁾,y⁽¹⁾), . . . (x⁽ⁿ⁾, y⁽ⁿ⁾)>. The model in this method is ƒ(x)=w^{T}ϕ(x) where ϕ(x) is the non-linear transformation mentioned above. The prediction error now becomes RSS(w)=Σₙ[yₙ−w^{T}ϕ(xₙ)]². Its solution w* is given by:

$$\frac{\partial }{\partial w} RSS ( w ) = {\sum }_{n} ( {y}_{n} - {w}^{T} φ ( {x}_{n} ) ) ( - φ ( {x}_{n} ) ) = 0$$

Solving the above equation and careful manipulation provides:

w*=Φ^{T}(K+λI)⁻¹y

where

Φ^{T}=(ϕ(x₁)ϕ(x₂) . . . ϕ(x_{N}))∈ [symbol] ^{D×N}

K=ΦΦ^{T}∈ [symbol] ^{N×N}

y=(y₁ y₂ . . . y_{N})^{T}

Thus, instead of Φ, K is specified which models the distance between the data points in the new space. Note that the above equations can be modified to include the effect of regularization on weights.

The prioritization component 120 takes the predicted values of physical output from candidate objects 1 through n and orders the candidate objects 1 though n based on the predicted values. Thus, the prioritization component 120 prioritizes the candidate objects 1 through n.

The selection component 122 utilizes the prioritization generated by the prioritization component 120 to select certain of the candidate objects on which to perform the physical process. The selection component 122 selects fewer than all of the candidate objects 1 through n. Thus, the selection component 122 selects a sub-set of the candidate objects 1 through n based on the prioritization.

The computing system 102 can also include a communication interface 130 configured to receive the time series history of measurements A₁ through Aₙ, B₁ through Bₙ, C₁ through Cₙ, and D₁ through Dₙ from candidate objects 1 through n, and transmit notifications as generated by the data processing framework 114, as well as a display 132 for presenting a user interface associated with the data processing framework 114. In various embodiments, the computing system 102 can include additional components, such as peripheral I/O devices, for example to allow a user to interact with the user interfaces generated by the data processing framework 114.

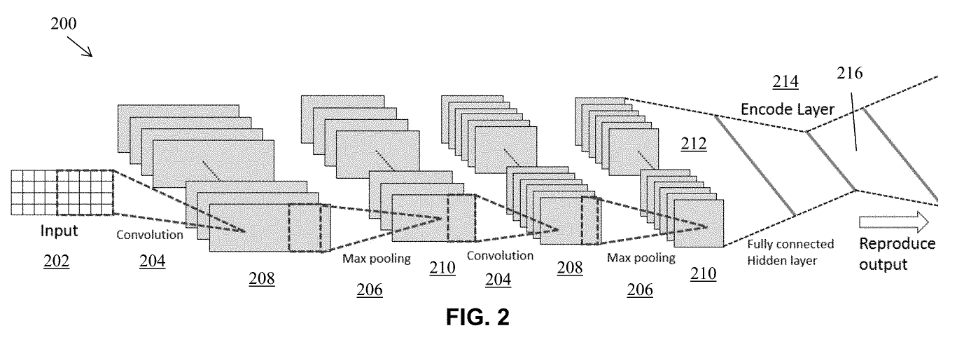

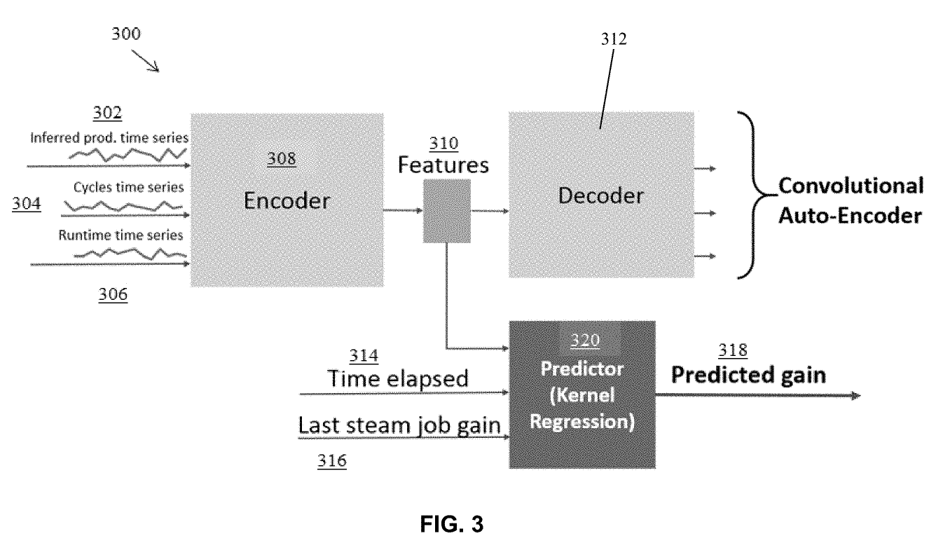

Referring now to FIGS. 2 and 3, an exemplary sequence of layers in the autoencoder component 116 is shown. The autoencoder component 116 includes a neural network 200, which has eleven layers. The encoder part 308 of the autoencoder component 116 consists of two convolution layers 204 then a max pooling layer pair 206 followed by a hidden layer 212. The decoder part 312 of the autoencoder component 116 is symmetric to the encoder part 308. The number of filters and the size of the filters can be varied to find the best hyperparameter to use. The encoder 308 can be trained by back propagation. The learning rates can be adjusted using RMSProp (see T. Tieleman and G. Hinton. Lecture 6.5-rmsprop. COURSERA: Neural networks for machine learning, 2012, which is incorporated by reference in its entirety herein), which is designed to work well for minibatches.

As illustrated, the input 202 (i.e., the time series history of measurements for each candidate object) goes through two convolutional layers 204. Each convolutional layer 204 provides a feature map layer 208 in the form of a matrix. Each convolutional layer 204 is followed by a sub-sampling layer. In this case, the subsampling layer is a max pooling layer 206. Each sub-sampling layer 206 provides a feature map layer 210, again in the form of a matrix. Performing subsampling reduces the number of intermediate values in the neural network to a number that is more reasonable to train. A fully connected layer hidden layer 212 follows the second feature map layer 210, then an encode layer 214 follows the fully connected hidden layer 212, and another fully connected hidden layer 216 follows the encode layer 214. The encode layer 214 provides the encoding corresponding to likelihoods of presence of the candidate objects, and the fully connected hidden layer 216 includes connections to each node in the previous layer, and outputs a vector having a dimension the same size as the number of classes of input from which a selection can be made, to ensure the output from the autoencoder component 116 has the same size as the input 202. The output is latent features for each candidate object.

A particular application of the methods and systems disclosed herein is in selecting candidate oil wells at which to perform a steam joto enhance oil production gain from among a plurality of oil wells. The method involves receiving a time series history of measurements for each of a plurality of oil wells at a data processing framework. The method further involves reducing dimensionality of the time series history of measurements with a convolutional autoencoder to obtain latent features for each of the plurality of oil wells. The method also involves applying a kernel regression model to the latent features to generate a predicted oil production gain for a steam job at each of the plurality of oil wells. The method additionally involves generating a prioritization of the plurality of oil wells based on the predicted oil production gains. The method involves selecting fewer than all of the plurality of oil wells on which to perform a steam job. The selected oil wells are based on the prioritization. The method for selecting candidate oil wells can further involve outputting to each of the selected oil wells an instruction to perform the steam job.

The steam job may be performed using a flow control device, a steam generator, and other equipment known to those of ordinary skill in the art. For example, a steam job (sometimes referred to as a steam injection) is discussed further in U.S. Pat. No. 9,284,826 and U.S. Patent Application Publication No. 2016/0281471, each of which is incorporated by reference in their entireties herein. Performing the steam job may also include using a choke or well control device. Chokes or well control devices can be used to control the flow of fluid into a well, out of a well, or any combination thereof. For example, well control devices may be utilized to control the injection rate of steam or other injectant into a well. For example, well control devices may be utilized to control the production rate of hydrocarbons from a well. For example, well control devices may be utilized to adjust the injection rate, production rate, or any combination thereof. The well control devices may also be used to control the pressure profiles in the wells. The wells can also fluidly connect with surface facilities (e.g., separators such as oil/gas/water separators, gas compressors, storage tanks, pumps, gauges, pipelines, etc.) at the surface. The rate of flow of fluids through the wells can depend on the fluid handling capacities of the surface facilities at the surface. The well control devices can be above surface and/or positioned downhole. Of note, some fluid may be injected and produced from the same well in some embodiments. On the other hand, some fluid may be injected into one well and some fluid may be produced from a different well in some embodiments.

A further particular application of the methods and systems disclosed herein is in identifying pumps experiencing slippage. This method involves receiving a time series history of measurements of, for example, fillage of the well and load in a pump. Such measurements can be derived from dynamometer measurements from pumps of wells, with measurements including a load carried by each stroke, max and min values of the load during each stroke, and depth of the pump. The method further involves reducing dimensionality of the time series history of measurements with a convolutional autoencoder to obtain latent features for each of the plurality of oil wells and/or pumps. The method also involves applying a classification model to the latent features to generate a decision of whether slippage is being experienced for each pump at each of the plurality of oil wells. The classification model can be, for example a logistic regression, and/or support vector machine (SVM) analysis. The method additionally involves generating a prioritization of the plurality of oil wells based on the determined slippage. The method involves selecting fewer than all of the plurality of oil wells on which to perform a test for slippage, to limit that test to those wells and/or pumps most likely to experience slippage. The selected oil wells are based on the prioritization. The method for selecting candidate oil wells can further involve outputting to each of the selected oil wells an instruction to perform the slippage testing.

Those of ordinary skill in the art will appreciate that the inventive concepts provided herein may be applied in various contexts. For example, the inventive concepts provided herein may be used for equipment for which measurements are available. The equipment may be on the surface, subsurface (e.g., downhole), subsea, or any combination thereof. The equipment may be at a hydrocarbon field (e.g., for injection, for production, or any combination thereof). The equipment may be at a surface facility. The equipment may be at a refinery.

In some embodiments, the inventive concepts may involve recognizing anomalous patterns in measurements associated with the operation of a piece of equipment. As such, the inventive concepts may be applied to many different types of equipment, such as, but not limited to a valve, a heat exchanger, a screen (e.g., a sand screen), a pump, a compressor, a pipe, a separator, a vessel, a tube (e.g., a tube in a fired heater), a column (e.g., a distillation column), or any combination thereof. For example, the inventive concepts may be applied for: (a) detection of sand screen failure or incipient failure using downhole measurements, (b) detection of problems with pumps or compressors, whether on the surface, subsurface (e.g., downhole), or subsea from measurements associated with the operation of such equipment (e.g., pressure differentials, vibration, flow rates, etc.), (c) detection of build-up in pipes using pressure and flow measurements, (d) detection of slug flow into a separator from pressure and level measurements associated with the vessel, (e) detection of coke build-up on tubes in a fired heater in a refinery with fuel flow, temperatures, and fluid flow rates measurements, (f) detection of distillation column mis-operation from temperatures along the column and pressure differential across the column, or any combination thereof.

Accordingly, disclosed herein is a computer-implemented method for identifying mis-operation of equipment. The method comprises receiving a time series history of measurements from a piece of equipment at a data processing framework. The method further comprises reducing dimensionality of the time series history of measurements with a convolutional autoencoder to obtain latent features for the piece of equipment. The method also comprises applying a kernel regression model to the latent features to generate a predicted value of physical output for performing a physical process on the piece of equipment. The method additionally comprises determining whether the piece of equipment is mis-operating based on the value of physical output.

In an embodiment, the piece of equipment is a valve, a heat exchanger, a screen, a pump, a compressor, a pipe, a separator, a vessel, a tube, a column, or any combination thereof. In an embodiment, the piece of equipment is on the surface, subsurface, subsea, or any combination thereof. In an embodiment, the times series history of measurements comprises pressure differentials, pressures, vibrations, flow rates, level measurements, temperatures, or any combination thereof. In an embodiment, the piece of equipment is a sand screen and the time series history of measurements comprises downhole measurements. In an embodiment, the piece of equipment is a pump or a compressor and the time series history of measurements comprises pressure differentials, vibrations, flow rates, or any combination thereof. In an embodiment, the piece of equipment is a pipe and the time series history of measurements comprises pressure and flow measurements. In an embodiment, the piece of equipment is a separator, the time series history of measurements comprises pressure and level measurements, and determining whether the piece of equipment is mis-operating comprises detecting the presence or absence of slug flow. In an embodiment, the piece of equipment is a fired heater in a refinery, the time series history of measurements comprises fuel flow, temperature, and fluid flow rate measurements, and determining whether the piece of equipment is mis-operating comprises detecting a level of coke build-up on tubes in the fired heater. In an embodiment, the piece of equipment is a distillation column and the time series history of measurements comprises temperatures and pressure differentials. In an embodiment, the method further comprises performing a corrective action upon determination that the piece of equipment is mis-operating. The corrective action can be repairing the piece of equipment or replacing the piece of equipment.

Also disclosed herein is a computer-implemented method for identifying mis-operation of equipment. The method comprises receiving a time series history of measurements from a piece of equipment at a data processing framework. The method further comprises utilizing a convolutional autoencoder to determine a pattern in the time series history of measurements. The method additionally comprises determining whether the pattern is anomalous.

In an embodiment, the piece of equipment is a valve, a heat exchanger, a screen, a pump, a compressor, a pipe, a separator, a vessel, a tube, a column, or any combination thereof. In an embodiment, the piece of equipment is on the surface, subsurface, subsea, or any combination thereof. In an embodiment, the times series history of measurements comprises pressure differentials, pressures, vibrations, flow rates, level measurements, temperatures, or any combination thereof. In an embodiment, the piece of equipment is a sand screen and the time series history of measurements comprises downhole measurements. In an embodiment, the piece of equipment is a pump or a compressor and the time series history of measurements comprises pressure differentials, vibrations, flow rates, or any combination thereof. In an embodiment, the piece of equipment is a pipe and the time series history of measurements comprises pressure and flow measurements. In an embodiment, the piece of equipment is a separator and the time series history of measurements comprises pressure and level measurements. In an embodiment, the piece of equipment is a fired heater in a refinery, and the time series history of measurements comprises fuel flow, temperature, and fluid flow rate measurements. In an embodiment, the piece of equipment is a distillation column and the time series history of measurements comprises temperatures and pressure differentials. In an embodiment, the method further comprises performing a corrective action upon determination that the pattern is anomalous. The corrective action can be repairing the piece of equipment or replacing the piece of equipment.

FIG. 3 illustrates a particular implementation of a system for selecting candidate objects at which to perform a steam job. The system 300 can be implemented using the system 100 described above with respect to FIGS. 1-2, and involves receiving a time series history of inferred production 302, a time series history of cycles 304, and a time series history of runtime 306 for each oil well at a data processing framework. An encoder 308 of the convolutional autoencoder reduces dimensionality of the time series history of inferred production 302, the time series history of number of cycles 304, and the time series history of runtime 306 to obtain latent features 310 for each oil well. Oil production gain 318 for a steam job at each oil well is then predicted by applying a kernel regression model 320 to the latent features 310 as well as percentage gain in production achieved by a last steam job 314 and time elapsed since the last steam job 316.

It is noted that the system 300 can be adapted to use in the context of a slippage test as well, with the extracted features provided to a predictor (kernel regression model 320 or other models like logistic regression) to determine likely wells for which slippage tests may be valuable.

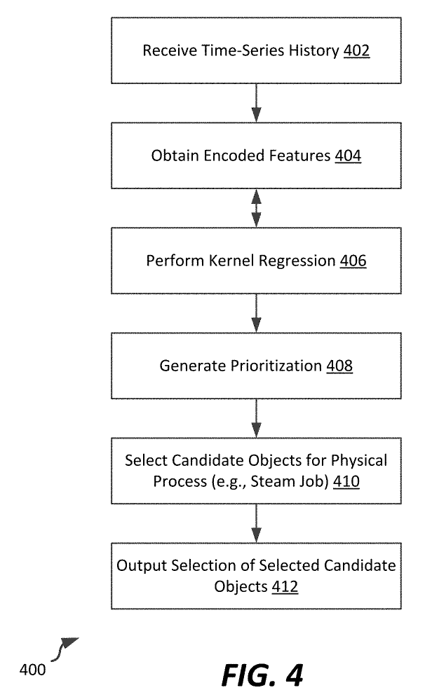

Referring now to FIG. 4, an example method 400 is illustrated for sorting and identifying candidate objects on which to perform a physical process is illustrated. The method 400 can be performed, for example, using the systems described above in connection with FIGS. 1-3.

In the example shown, the method 400 includes receiving a time-series history of measurements from each candidate object to be considered (step 402), at a data processing framework, such as that seen above in FIG. 1. The time-series history can be any of a variety of time-step data or time-stamped data, and the candidate objects can be objects from among which a physical process is to be performed. In a particular example, the physical process can be a steam job, with the candidate object being a candidate well.

The method 400 includes obtaining latent features for each of the candidate objects (step 404). Obtaining latent features can be performed by reducing dimensionality of that time series history of measurements. In example embodiments, a convolutional autoencoder can be used to reduce dimensionality, as illustrated above in FIGS. 2-3.

The method 400 includes applying a kernel regression model to latent features to generate a predicted value of physical output in response to performing the physical process on each of the plurality of candidate objects (step 406). This predicted value corresponds to a value for each individual candidate object, and can correspond in the case of a steam joto an extent of additional production from a candidate well in response to conducting the steam job at that well.

The method 400 includes prioritizing the candidate objects (step 408). In example embodiments, the candidate objects are prioritized by being ranked or sorted by predicted value. The method 400 also includes selecting a subset of the plurality of candidate objects on which to perform the physical process (step 410). The subset generally includes fewer than all of the plurality of candidate objects, and can be selected in a number of ways. For example, a top predetermined number of candidate objects, or top number of candidate objects that meet predetermined criteria can be selected.

The method 400 also includes, in some embodiments, output of the selection of candidate objects (step 412). The output of selected candidate objects can be, for example, an output of the selected candidate objects to a display, or transmission of an instruction to a remote system or systems to initiate the physical process with respect to one or more, or each, of the selected candidate objects. For example, the output can, in some cases, correspond to issuing an instruction to initiate a steam flood job at each selected candidate well.

In the methods and systems discussed herein, the prioritization can rank the candidate objects in descending order from the candidate object with the highest value of predicted physical output to the candidate object with the lowest value of predicted physical output. Alternatively, the prioritization can rank the candidate objects in ascending order from the candidate object with the lowest value of predicted physical output to the candidate object with the highest value of predicted physical output.

The selected candidate objects in the methods and systems discussed herein can comprise a top predetermined number of the plurality of candidate objects (where the prioritization ranks the candidate objects in descending order from the candidate object with the highest value of predicted physical output to the candidate object with the lowest value of predicted physical output). In an embodiment, the selected candidate objects are the top 10 of the plurality of candidate objects. In another embodiment, the selected candidate objects are the top 25 of the plurality of candidate objects. In yet another embodiment, the selected candidate objects are the top 50 of the plurality of candidate objects. In a further embodiment, the selected candidate objects are the top 100 of the plurality of candidate objects.

In the methods and systems disclosed herein, the convolutional autoencoder comprises a neural network. In some embodiments, the neural network comprises an eleven layer neural network. The neural network can comprise stacked convolutional layers. For example, the eleven layer neural network can comprise two convolutional layers. The neural network can also comprise more one or more fully connected layers. For example, the eleven layer neural network can comprise two fully connected layers.

In an embodiment, an activation function in each convolutional layer of the convolutional autoencoder is:

ƒ(x)=max(0,x),

where x is the input.

In the methods and systems disclosed herein, applying the kernel regression model can include utilizing a kernel function, wherein the function is:

k(xₘ,xₙ)=e^{-∥x}^{ₘ}^{-x}^{ₙ}^{∥}^{²}^{/2σ}^{²},

where σ² is the variance of the Gaussian Kernel, x corresponds to a data point within the time series history of measurements, and m and n correspond to indices of input vectors to the kernel regression model.

Rectified Linear Units (ReLUs) is widely used in deep learning models because of its numerous advantages over classic activation functions like sigmoid and tanh. It is defined as

ƒ(x)=max(0,x),

ReLUs are much more computationally efficient, there is also no vanishing or exploding gradient problems. It also gives a sparse representation, as about 50% of the activation units will output zeros.

In the methods and systems disclosed herein, the time series history of measurements can span anywhere from a number of days to a number of years. For example, the time series history of measurements can be a month to five years, a month to four years, a month to three years, a month to two years, a month to a year, or a month to 100 days. As another example, the time series history of measurements can span a month, 100 days, a year, two years, three years, four years, or five years.

Advantageously, the methods and systems disclosed herein can accurately select candidate objects on which to perform a physical process to achieve the greatest benefit (i.e., physical output). The accuracy of selection of the methods and systems (based on comparing the predicted physical output to the actual physical output) can be, for example, greater than 90% or greater than 95%. Accuracy is especially important where resources for the physical process are limited (e.g., steam for a steam job) and/or the physical process is time consuming and/or costly.

Also, advantageously, the methods and systems disclosed herein can achieve greater benefit (i.e., physical output) than can be achieved without the disclosed methods and systems using a convolutional autoencoder and a kernel regression model. Example 2 below illustrates this with regard to selection of candidate oil wells for a steam job. In an embodiment, an average value of physical output of the selected candidate objects is at least 50% greater than the average value of physical output of the same number of candidate objects selected without the method or system. In another embodiment, an average value of physical output of the selected candidate objects is at least 25% greater than the average value of physical output of the same number of candidate objects selected without the method or system. In yet another embodiment, an average value of physical output of the selected candidate objects is at least 75% greater than the average value of physical output of the same number of candidate objects selected without the method or system. In a further embodiment, an average value of physical output of the selected candidate objects is at least 100% greater than the average value of physical output of the same number of candidate objects selected without the method or system. Other advantages are apparent as well from the present disclosure, as are apparent herein.

### EXAMPLES

In accordance with the previous description, example models have been tested to determine a selected set of top candidates for a particular candidate object. In the examples shown, the candidate objects are candidate oil wells that are identified for purposes of conducting steam jobs at such candidate wells, or candidate pumps at which slippage may be possible.

### Examples 1-2: Steam Job Modeling Using Autoencoder

Time series history of inferred production, time series history of number of cycles, and time series history of runtime (all for the last 100 days) were fed to an autoencoder. The autoencoder provided latent features based on the described input and these latent features were fed to the kernel regression model as well as last steam job gain and time elapsed since the last steam job for each well. The time series history measurements as well as last steam job gain and time elapsed since the last steam job for 1000 wells and 4000 steam jobs spanning a total of two years were used. This data was divided into a training data set, a testing data set and a validation data set.

### Validation

The validation set was used to select the following hyperparameters. For the autoencoder, the hyperparameters were learning rate, number of filters, and size of encoded layer in each layer. These were chosen by doing a grid search on [0.1, 0.99] for learning rate, {16, 32, 64} for number of filters, and {5, 10, 20} for size of encoded layer. For kernel regression (Gaussian Kernel), the hyperparameter was the variance of Gaussian. This was chosen by doing a grid search on [1 e−6, 1e+6] in multiplicative steps of 10.

### Example 1

A total data set of 4000 steam jobs was randomly split into training and test sets consisting of 3200 and 800 steam jobs, respectively. The training set was further divided (5:1 split) for the purpose of validation. Each data point can be thought of as a (well_id, day) pair. Thus, if a well was steamed 5 times in the data set, there was 5 data points corresponding to that well. The model was trained with the training set. The model was tested with the test set.

The model was evaluated with the following: mean square error, Spearman correlation, overlap coefficient (n), and top k in K.

Mean square error is the average of the square of the difference between the predicted value and the actual value and evaluates how close the predicted production is to actual production. Lower mean square error implies that the predicted production is close to actual production.

Spearman correlation, overlap coefficient, and top k in K focus on the rank of wells (based on production) instead of raw production values.

Spearman correlation is the Pearson correlation between the ranked variables (i.e., the correlation between predicted ranks of wells and the rank of wells from actual production). High correlation implies that the model ranks the oil wells well.

For sets X and Y, overlap coefficient is defined as:

$$overlap ( X , Y ) = \frac{\vert X ⋂ Y \vert}{min ( \vert X \vert , \vert Y \vert )}$$

Wells were ordered in decreasing order of production by both actual production and predicted production. The top n wells of both of these lists were then compared. The term overlap(n) if means both lists have n elements.

Top k in K is defined as the overlap coefficient between two lists—one of size k (predicted production) and one of size K (actual production). Top k in K can be defined as the percentage of wells in the top k predicted production which are in the top K of actual production. This can be used in conjunction with overlap(n) to understand the quality of the predicted production, which does not match with the top n wells from the actual production.

The results for the first set of experiments are in Table 1. The results are compared to results from three different models—Random Prediction Model, Linear Regression with manual features and Kernel Regression with manual features. The model using the autoencoder resulted in much better predictions.

TABLE 1

| | Analysis | | | |
|---|---|---|---|---|
| | | Linear | Kernel | |
| | Random | Regression | Regression | Model |
| | Prediction | (manual | (manual | Using |
| | Model | features) | features) | Autoencoder |
| Mean Square | 343.9 | 300 | 3.69 | 1.54 |
| Error | | | | |
| Spearman | 0 | 0.17 | 0.42 | 0.7 |
| Correlation | | | | |
| Overlap | ~0.025 | 0.14 | 0.46 | 0.66 |
| Coefficient (25) | | | | |
| Overlap | ~0.05 | 0.16 | 0.5 | 0.68 |
| Coefficient (50) | | | | |
| Overlap | ~0.1 | 0.22 | 0.52 | 0.71 |
| Coefficient (100) | | | | |
| Top 10 in 20 | ~0.02 | 0.2 | 0.6 | 0.97 |
| Top 25 in 50 | ~0.05 | 0.17 | 0.66 | 0.97 |
| Top 50 in 100 | ~0.1 | 0.18 | 0.64 | 0.98 |
| Top 100 in 200 | ~0.2 | 0.27 | 0.62 | 0.94 |

As shown in Table 1, Kernel Regression improved upon the Random Prediction Model significantly. Mean square error was reduced by about 100 times using Kernel Regression. The model using the autoencoder further reduced the error by 2 times. Also, other measures like Spearman correlation, overlap coefficient and top 50 in 100 are notably improved using the model using the autoencoder. The model using the autoencoder obtained a value of 0.98 for the metric “Top 50 in 100”. This means that almost all the top 50 predictions are at least in the actual top 100.

### Example 2

For the second set of experiments, the two year steam job data was divided into two sets—first year and second year. The number of steam jobs performed by the engineers (k) in an interval of d days after the first year was examined. The model was trained on the first year data set and predicted the top k candidates at the end of the year. This permitted comparison of the wells predicted by the model directly against the wells chosen by engineers (by approximating the gain of a steam job on a particular well within d days after year 1 with the gain of the first steam job performed on that well in the second year).

The second set of experiments provided an average percentage production gain of 176%. In contrast, the average percentage production gain achieved by the engineers was 124%.

### Further Example Notes—Effects of Other Hyperparameters

In addition to the experiments above, further tests were performed in which other hyperparameters were identified, including a number of feature maps, size and shape of a filter, number of intermediate layers, and size of the encode layer, to determine the effects of such parameters on the analysis.

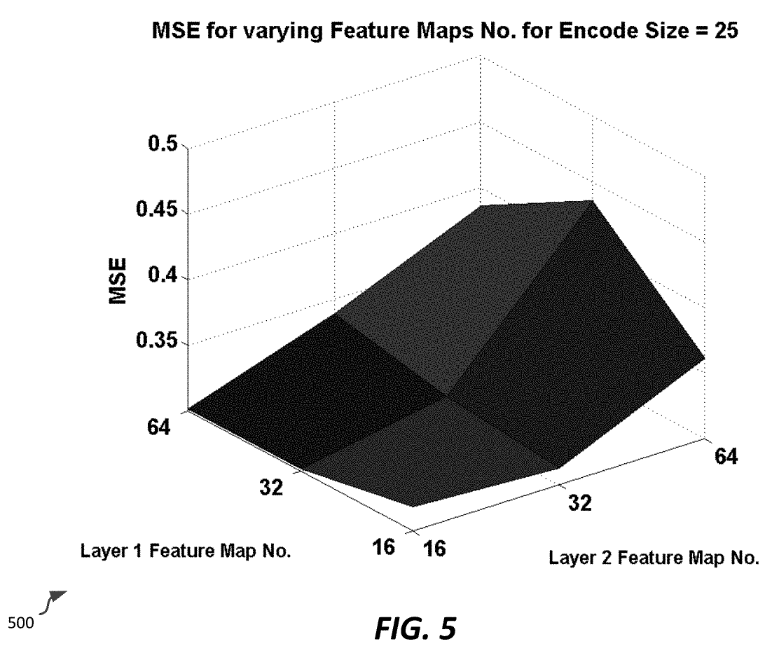

In particular, the number of feature maps has a correlation to reconstruction error, in that it is optimal to have more feature maps in a first convolutional layer and fewer feature maps in a subsequent convolutional layer. Such an effect is seen in the graph 500 of FIG. 5. Although in typical convolutional neural networks in which a number of feature maps increase in subsequent convolutional layers, it is possible that in this case, due to time series data being less complex than in other applications (e.g., image recognition), most useful features are captured in initial layers.

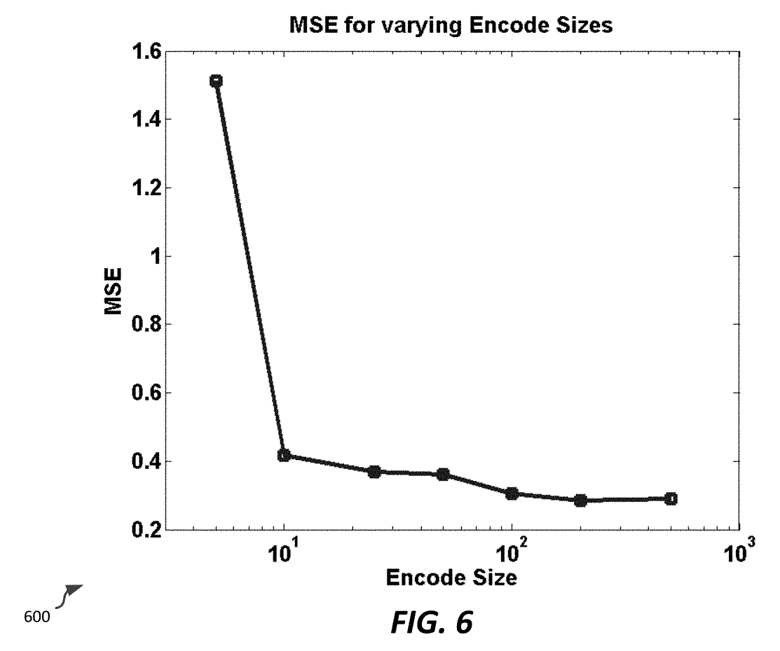

The size of the encode layer was determined based on accuracy of the regression or classification model, since reconstruction error decreases with increase in encode layer size. FIG. 6 illustrates a chart 600 showing, for steam job prediction, a mean square error relative to encode size. A correct encode size is selected based on accuracy of a regression model.

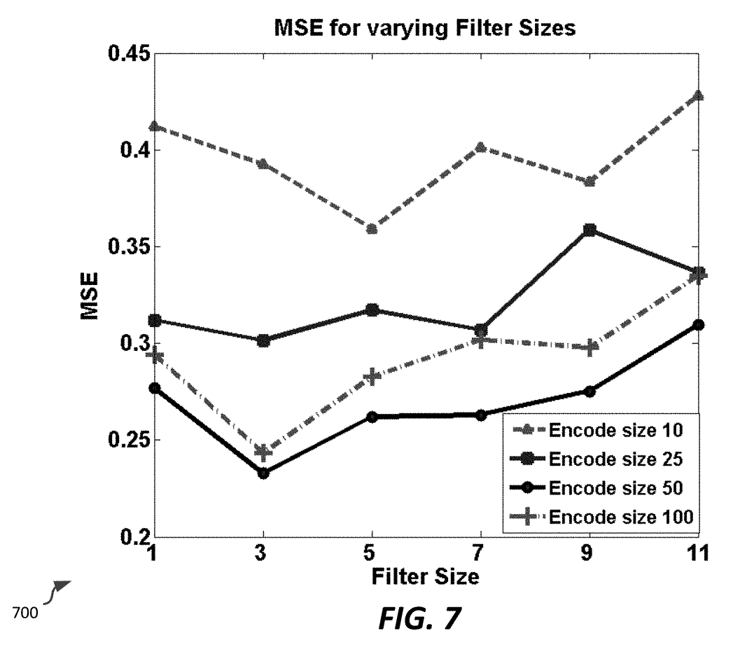

The size and shape of the filter can also have an effect on reconstruction error. As illustrated in FIG. 7, a graph 700 illustrates mean square error relative to filter size, across different encode sizes. For example, as illustrated 3×3 and 3×5 filters provide lowest error performance across encode sizes, with large filters tending to overfit as a number of parameters increase (e.g., in encode size 50, 100).

### Example 3: Slippage Detection Modeling Using Autoencoder

Time series history of measurements for periods of time where wells are suffering from outflow problems and when the well is operating normally are used to train a model. Of a given data set 80% was used as training and validation data, and 20% used as test data, with the results being evaluated by classification accuracy, e.g., the percentage of data points classified correctly.

### Validation

In assessing the use of such autoencoder-based assessment for slippage, history size and encode size for logistic regression was assessed. Grid searching was used to determine best parameters for the autoencoder. Generally, it is observed, in Table 3, below, that increase of encode size does not necessarily improve accuracy; however, increase of history size assists with improved classification.

### Example 3

In assessing the use of such autoencoder-based assessment for slippage, history size and encode size for logistic regression was assessed. Grid searching was used to determine best parameters for the autoencoder. Generally, it is observed, in Table 2, below, that increase of encode size does not necessarily improve accuracy; however, increase of history size assists with improved classification.

TABLE 2

| | Encode Size | | |
|---|---|---|---|
| History Size | 10 | 25 | 50 |
| 30 | 0.616 | 0.618 | 0.617 |
| 45 | 0.5 | 0.653 | 0.653 |
| 60 | 0.5 | 0.702 | 0.703 |

As seen above, the best accuracy of 70.3% is obtained with a history size of 60 and encode size 50. Furthermore, and as illustrated in Table 3, below, logistic regression performs better than support vector machines in general in this case. The best classification accuracy achieved is 70.3%.

TABLE 3

| | | Logistic | |
|---|---|---|---|
| History Size | Random | Regression | SVM |
| 10 | 0.5 | 0.617 | 0.612 |
| 25 | 0.5 | 0.653 | 0.582 |
| 50 | 0.5 | 0.703 | 0.655 |

Referring generally to the methods and systems of FIGS. 1-7, disclosed herein is a computer-implemented method for prioritizing candidate objects on which to perform a physical process. The method comprises receiving a time series history of measurements from each of a plurality of candidate objects at a data processing framework. The method further comprises reducing dimensionality of the time series history of measurements with a convolutional autoencoder to obtain latent features for each of the plurality of candidate objects. The method also comprises applying a kernel regression model to the latent features to generate a predicted value of physical output for performing the physical process on each of the plurality of candidate objects. The method comprises generating a prioritization of the candidate objects based on the values of physical output. The method additionally comprises selecting fewer than all of the plurality of candidate objects on which to perform the physical process. The selected candidate objects are based on the prioritization.

In an embodiment, the method further comprises outputting to each of the selected candidate objects an instruction to perform the physical process.

Also disclosed herein is a system. The system comprises a processor and a memory operatively connected to the processor. The memory stores instructions that, when executed by the processor, cause the system to reduce dimensionality of a time series history of measurements from each of a plurality of candidate objects with a convolutional autocoder to obtain latent features for each of the plurality of candidate objects; apply a kernel regression model to the latent features to generate a predicted value of physical output for performing a physical process on each of the plurality of candidate objects; generate a prioritization of the candidate objects based on the values of physical output; and select fewer than all of the plurality of candidate objects on which to perform the physical process. The selected candidate objects are based on the prioritization.

In an embodiment of the system, the instructions, when executed by the process, further cause the system to output to each of the selected candidate objects an instruction to perform the physical process.

In embodiments of the methods and systems disclosed herein, the candidate objects can be candidate oil wells and the physical process can be a steam job. The physical output can be oil production gain, oil production flow rate, or total oil production. The time series history of measurements can comprise inferred production, number of cycles, and runtime.

In the methods and systems disclosed herein, the kernel regression model can applied to an input in addition to the latent features that is related to past occurrences of the physical process. For example, the additional input to the kernel regression model can comprise percentage gain in production achieved by a last steam job and time elapsed since the last steam job.

Referring in particular to computing systems embodying the methods and systems of the present disclosure, it is noted that various computing systems can be used to perform the processes disclosed herein. For example, embodiments of the disclosure may be practiced in various types of electrical circuits comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, aspects of the methods described herein can be practiced within a general purpose computer or in any other circuits or systems.

Embodiments of the present disclosure can be implemented as a computer process (method), a computing system, or as an article of manufacture, such as a computer program product or computer readable media. The computer program product may be a computer storage media readable by a computer system and encoding a computer program of instructions for executing a computer process. Accordingly, embodiments of the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media. Further, the disclosed methods' stages may be modified in any manner, including by reordering stages and/or inserting or deleting stages, without departing from the overall concept of the present disclosure.

The above specification, examples and data provide a complete description of the manufacture and use of the invention. Since many embodiments of the invention can be made without departing from the spirit and scope of the invention, the invention resides in the claims hereinafter appended.

1. A computer-implemented method for identifying mis-operation of equipment, the method comprising:
receiving a time series history of measurements from a piece of equipment at a data processing framework;
reducing dimensionality of the time series history of measurements with a convolutional autoencoder to obtain latent features for the piece of equipment;
applying a kernel regression model to the latent features to generate a predicted value of physical output for performing a physical process on the piece of equipment; and
determining whether the piece of equipment is mis-operating based on the value of physical output.

2. The method of claim 1, wherein the piece of equipment is a valve, a heat exchanger, a screen, a pump, a compressor, a pipe, a separator, a vessel, a tube, a column, or any combination thereof.

3. The method of claim 1, wherein the piece of equipment is on the surface, subsurface, subsea, or any combination thereof.

4. The method of claim 1, wherein the times series history of measurements comprises pressure differentials, pressures, vibrations, flow rates, level measurements, temperatures, or any combination thereof.

5. The method of claim 1, wherein the piece of equipment is a sand screen and the time series history of measurements comprises downhole measurements.

6. The method of claim 1, wherein the piece of equipment is a pump or a compressor and the time series history of measurements comprises pressure differentials, vibrations, flow rates, or any combination thereof.

7. The method of claim 1, wherein the piece of equipment is a pipe and the time series history of measurements comprises pressure and flow measurements.

8. The method of claim 1, wherein the piece of equipment is a separator, the time series history of measurements comprises pressure and level measurements, and determining whether the piece of equipment is mis-operating comprises detecting the presence or absence of slug flow.

9. The method of claim 1, wherein the piece of equipment is a fired heater in a refinery, the time series history of measurements comprises fuel flow, temperature, and fluid flow rate measurements, and determining whether the piece of equipment is mis-operating comprises detecting a level of coke build-up on tubes in the fired heater.

10. The method of claim 1, wherein the piece of equipment is a distillation column and the time series history of measurements comprises temperatures and pressure differentials.

11. The method of claim 1, further comprising performing a corrective action upon determination that the piece of equipment is mis-operating.

12. A computer-implemented method for identifying mis-operation of equipment, the method comprising:
receiving a time series history of measurements from a piece of equipment at a data processing framework;
utilizing a convolutional autoencoder to determine a pattern in the time series history of measurements; and
determining whether the pattern is anomalous.

13. The method of claim 12, wherein the piece of equipment is a valve, a heat exchanger, a screen, a pump, a compressor, a pipe, a separator, a vessel, a tube, a column, or any combination thereof.

14. The method of claim 12, wherein the piece of equipment is on the surface, subsurface, subsea, or any combination thereof.

15. The method of claim 12, wherein the times series history of measurements comprises pressure differentials, pressures, vibrations, flow rates, level measurements, temperatures, or any combination thereof.

16. The method of claim 12, wherein the piece of equipment is a sand screen and the time series history of measurements comprises downhole measurements.

17. The method of claim 12, wherein the piece of equipment is a pump or a compressor and the time series history of measurements comprises pressure differentials, vibrations, flow rates, or any combination thereof.

18. The method of claim 12, wherein the piece of equipment is a pipe and the time series history of measurements comprises pressure and flow measurements.

19. The method of claim 12, wherein the piece of equipment is a separator and the time series history of measurements comprises pressure and level measurements.

20. The method of claim 12, wherein the piece of equipment is a fired heater in a refinery, and the time series history of measurements comprises fuel flow, temperature, and fluid flow rate measurements.

21. The method of claim 12, wherein the piece of equipment is a distillation column and the time series history of measurements comprises temperatures and pressure differentials.

22. The method of claim 12, further comprising performing a corrective action upon determination that the pattern is anomalous.
